(19) United States
(12) Patent Application Publication
(10) Pub. No.: US 2023/0369747 A1
(43) Pub. Date: Nov. 16, 2023

(54) RADIATOR, ANTENNA AND BASE STATION

(71) Applicant: Nokia Shanghai Bell Co., Ltd., Shanghai (CN)

(72) Inventors: Wenmin YANG, Shanghai (CN); Guangyong He, Shanghai (CN); Yonghui Jiang, Shanghai (CN); Chengming Liu, Shanghai (CN)

(73) Assignee: Nokia Shanghai Bell Co., Ltd., Shanghai (CN)

(21) Appl. No.: 18/314,928

(22) Filed: May 10, 2023

(30) Foreign Application Priority Data
May 10, 2022 (CN) 202210542831.6

(51) Int. Cl. H01Q 1/24; H01Q 9/04; H01Q 19/10; H01Q 21/24

(52) U.S. Cl. CPC H01Q 1/246; H01Q 9/0407; H01Q 19/10; H01Q 21/245

(57) ABSTRACT

The present disclosure provides a radiator, an antenna, and a base station. The radiator comprises a conductor adapted to be arranged in an antenna for transmitting and/or receiving electromagnetic waves; and a pair of slots formed in the conductor and intersecting at a predetermined angle, each of the pair of slots comprising an elongated section at the middle thereof and widened sections at both ends thereof such that the conductor is divided by the pair of slots into: a continuous outer frame portion; and an enclosed portion surrounded by and connected to the continuous outer frame portion. Thus, the bandwidth of the patch antenna can be significantly broadened while maintaining the advantages of light weight, easy layout, wide range of applications, small size, low cost, etc.

### FIELD

Embodiments of the present disclosure generally relate to an antenna, and more particularly, to a radiator, an antenna, and a base station.

### BACKGROUND

The wireless mobile communication industry is currently developing rapidly. The capacity of a wireless mobile communication system is closely related to the use of frequency. The frequency spectrum relied upon by a wireless communication device is a limited natural resource. One major problem with a radio communication system is the limited availability of the radio spectrum due to the high demand Thus, an ideal mobile system is defined as a system that operates within a limited designated frequency band but provides service to an almost unlimited number of users.

This inevitably involves in providing radio coverage in multiple frequency bands and complicates the design of a transceiver in a network base station. In terms of antennas, the expense of multi-base station antenna installation and public resistance to unsightly antenna placement has prompted the installation of multi-band antennas at base stations, which avoids using antenna masts and increasing the cost. Microstrip patch antenna (MPA) is a kind of planar antenna widely studied and developed in recent forty years. They gain the favor of antenna designers and have found use in many applications in wireless communication systems thanks to light weight, ease of placement, wide range of applications, compactness and low cost.

### SUMMARY

A microstrip patch radiation element often suffers from electromagnetic coupling and the like, which reduces efficiency, correlation and ultimately deteriorates the communication quality of the overall antenna system. To at least partially address the above and other potential problems, example embodiments of the present disclosure provide a radiator, and an antenna and an associated base station.

In a first aspect of the present disclosure, there is provided a radiator. The radiator comprises a conductor adapted to be arranged in an antenna for transmitting and/or receiving electromagnetic waves; and a pair of slots formed in the conductor and intersecting at a predetermined angle, each of the pair of slots comprising an elongated section at the middle thereof and widened sections at both ends thereof such that the conductor is divided by the pair of slots into: a continuous outer frame portion; and an enclosed portion surrounded by and connected to the continuous outer frame portion.

The conductor is divided into the continuous outer frame portion and the enclosed portion by slots formed in the conductor, so that an antenna using the conductor can be operated in two modes, i.e., a patch antenna mode and a dipole antenna mode. Thus, the bandwidth of the patch antenna can be significantly broadened while maintaining the advantages of light weight, easy layout, wide range of applications, small size, low cost, etc.

In an exemplary embodiment, the radiator further comprises two pairs of feeding conductors for feeding the conductor.

In an exemplary embodiment, the two pairs of feeding conductors are arranged to support the conductor and comprise a first pair of feeding conductors and a second pair of feeding conductors

In some embodiments, the enclosed portion comprises a first pair of radiation elements coupled to a first feeding unit through the first pair of feeding conductors; and a second pair of radiation elements coupled to a second feeding unit through the second pair of feeding conductors.

In some embodiments, the radiator is configured to operate electromagnetic waves having different polarization directions by feeding different feeding currents through the first feeding unit and the second feeding unit.

In some embodiments, each of the first pair of radiation elements and the second pair of radiation elements comprises: a pair of radiation conductors symmetrical with respect to an intersection center of a diagonal of the conductor, each radiation conductor comprising a feeding portion defined by the elongated sections of the pair of slots and connected to a corresponding one of the first and second feeding units; and a connecting arm defined by the widened sections of the pair of slots for connecting the feeding portion and the continuous outer frame portion.

In some embodiments, the connecting arm extends diagonally.

In some embodiments, each of the widened sections has a gradually increasing or stepwise increasing width in a direction from a center to an end.

In some embodiments, the pair of slots are orthogonal to each other.

In some embodiments, the conductor has one or more of the following shapes: rhombus, diamond, circle, oval, rectangle, hexagon, octagon, parallelogram and trapezoid.

In some embodiments, the continuous outer frame portion and the enclosed portion are arranged in the same plane.

In some embodiments, the radiator is a patch-structure radiator.

In some embodiments, the radiator further comprising at least one parasitic radiation element arranged above the conductor.

In a second aspect of the present disclosure, there is provided an antenna. The antenna comprises the radiator according to the first aspect of the present disclosure; at least one reflector on which the plurality of radiators are supported, the at least one reflector being configured to reflect a portion of electromagnetic waves radiated by the plurality of radiators; and a first feeding unit and a second feeding unit, both of which are configured to feed a plurality of radiators.

In some embodiments, the antenna comprises a large-scale MIMO antenna, a wideband antenna, or a multi-band antenna.

In a third aspect of the present disclosure, there is provided a base station. The base station comprises the at least one antenna according to the second aspect of the present disclosure.

It is to be understood that the Summary is not intended to identify key features or essential features of the present disclosure, nor is it intended to be used to limit the scope of the present disclosure. Other features of the present disclosure will become readily apparent from the following description.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a perspective view of a radiator in prior art;

FIG. 2 illustrates a top view and a perspective view of a portion of an array antenna used as a multi-band antenna according to an example embodiment of the present disclosure;

FIG. 3 illustrates a top view and a perspective view of a portion of an array antenna used as a MIMO antenna according to an example embodiment of the present disclosure;

FIG. 4 illustrates a top view of a conductor according to an example embodiment of the present disclosure;

FIG. 5 illustrates a schematic top view of slots formed in the conductor shown in FIG. 4;

FIG. 6 illustrates a continuous outer frame portion and an enclosed portion formed by slots, with the enclosed portion highlighted, according to an example embodiment of the present disclosure;

FIG. 7 illustrates some possible shapes of slots formed in a conductor of a radiator according to an example embodiment of the present disclosure;

FIG. 8 illustrates a perspective view of a radiator according to an example embodiment of the present disclosure;

FIG. 9 illustrates a perspective view of a radiator arranged on a reflector according to an exemplary embodiment of the present disclosure;

FIG. 10 illustrates a side view of a radiator arranged on a reflector according to an exemplary embodiment of the present disclosure;

FIGS. 11 and 12 illustrate current distribution and pattern diagram for an antenna according to an example embodiment of the present disclosure;

FIG. 13 illustrates a schematic diagram of a pattern of radiators according to an exemplary embodiment of the present disclosure;

FIG. 14 illustrates a radiation pattern and S11, S21, and S22 curves of an antenna according to an example embodiment of the present disclosure;

FIG. 15 illustrates a perspective view of a radiator arranged on a reflector according to an exemplary embodiment of the present disclosure; and

FIG. 16 illustrates the curves S11, S21, and S22 for antennas according to an example embodiment of the present disclosure.

In the various figures, the same or corresponding reference numerals indicate the same or corresponding parts.

### DETAILED DESCRIPTION OF EMBODIMENTS

The present disclosure will be described with reference to a few exemplary embodiments. It is to be understood that these examples are described to enable those skilled in the art to better understand and thereby implement the present disclosure, but are not intended to suggest any limitation as to the scope of the disclosure.

References in the disclosure to “one embodiment”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is considered that the combination with other embodiments to apply the particular feature, structure, or characteristic lies within the knowledge of one skilled in the art whether or not explicitly described.

It is to be understood that, although the terms “first” and “second”, etc. may be used herein to describe various elements, these elements should not be limited by these terms. These terms are only used to distinguish one element from another. For example, a first element may be termed a second element, and similarly, a second element may be termed a first element, without departing from the scope of the example embodiments. As used herein, the term “and/or” includes any combination and all combinations of one or more of the listed terms.

The term used herein is for the purpose of describing particular embodiments only and is not intended to be limiting of the exemplary embodiments. As used herein, the singular forms “a”, “an”, and “the” are intended to include the plural forms as well, unless the context clearly indicates otherwise. It will be further understood that the terms “comprises”, “comprising”, and/or “having”, when used herein, specify the presence of stated features, elements, and/or components, but do not preclude the presence or addition of one or more other features, elements, components, and/or groups thereof.

As used herein, the term “includes” and its variants are to be read as open-ended terms that mean “includes, but is not limited to.” The term “based on” is to be read as “based at least in part on.” The terms “one example embodiment” and “one embodiment” are to be read as “at least one example embodiment.” The term “a further embodiment” is to be read as “at least a further embodiment.”

As used herein, the term “circuit” refers to one or more of the following:
(a) A hardware circuit implementation only (such as analog and/or digital circuit implementations only); and
(b) A combination of hardware circuit and software, such as (if applicable): (i) A combination of analog and/or digital hardware circuit and software/firmware, and (ii) any portion of a hardware processor and software (including a digital signal processor, software, and memory that work together to cause an apparatus such as an OLT, ONU, or other computing device to perform various functions); and
(c) A hardware circuit and/or processor, such as a microprocessor or a portion of a microprocessor, requires software (e.g., firmware) for operation, but software may be absent if not required for operation.

The definition of a circuit applies to all usage scenarios of that term in the present application, including any claims. As another example, the term “circuit” as used in the present application also encompasses an implementation of only a hardware circuit or processor (or processors) or a portion of a hardware circuit or processor and its accompanying software and/or firmware. The term circuit also encompasses, for example, a baseband integrated circuit or a processor integrated circuit or a server for a mobile device, a cellular network device or other similar integrated circuit in a computing or network device, if applicable to a particular claim element.

The term “communication network” as used herein refers to a network that complies with any suitable communication standard, such as New Radio (NR), long Term Evolution (LTE), advanced LTE (LTE-A), wideband Code Division Multiple Access (WCDMA), high Speed Packet Access (HSPA), narrowband Internet of Things (NB-IoT), etc. Moreover, communication between terminal devices and network devices in a communication network may be in accordance with any suitable generation communication protocol, including, but not limited to, first generation (IG), second generation (2G), 2.5G, 2.75G, third generation (3G), fourth generation (4G), 4.5G, fifth generation (5G) communication protocols, and/or any other currently known or later developed protocols. Embodiments of the present disclosure may be applied to various communication systems. Given the rapid evolution of communications, there will of course be future types of communication technologies and systems in which the present disclosure may be implemented. The scope of the present disclosure should not be considered limited to the above-described systems.

The term “network device” as used herein refers to a node in a communication network through which a terminal device accesses the network and receives services therefrom. The network device may refer to a base station (BS) or an access point (AP), such as a Node B (Node B or NB), an evolved Node B (eNodeB or eNB), an NR NB (also referred to as gNB), a remote radio unit (RRU), a radio header (RH), a remote radio header (RRH), a relay, a low power node, and technology.

The term “terminal device” as used herein refers to any terminal device capable of wireless communication. By way of example, and not limitation, the terminal device may also be referred to as a communication device, a user equipment (UE), a subscriber station (SS), a portable subscriber station, a mobile station (MS), or an access terminal (AT). The terminal device may include, but is not limited to, a mobile phone, a cellular phone, a smart phone, a voice over Internet protocol (VoIP) phone, a wireless local loop phone, a tablet computer, a wearable terminal device, a personal digital assistant (PDA), a portable computer, a desktop computer, an image capturing terminal device such as a digital camera, a game terminal device, a music storage and playback device, an in-vehicle wireless terminal device, a wireless terminal, a mobile station, a laptop embedded device (LEE), a USB dongle, a smart device, a wireless client device (CPE), an Internet of Things (IoT) device, a watch or other wearable devices, head mounted displays (HMDs), a vehicle, an unmanned aerial vehicle, a medical device and applications (e.g., telesurgery), an industrial device and applications (e.g., a robot and/or other wireless devices operating in an industrial and/or automated processing chain environment), a consumer electronic, a device operating on commercial and/or an industrial wireless network, etc. In the following description, the terms “terminal device”, “communication device”, “terminal”, “user equipment” and “UE” are used interchangeably.

In a communication network in which multiple network devices are jointly deployed in a geographic area to serve various cells, the terminal device may have an active connection with a network device when located within a corresponding cell. In an active connection, the terminal device may communicate with the network device on uplink (UL) and downlink (DL) frequency bands. The terminal device may need to switch a link in one direction, such as the UL, to another network device for various reasons, such as quality degradation in the UL.

Currently, the communication technology has evolved to a fifth generation of new radios, also referred to as 5G NR, featured by an antenna device typically comprising larger antenna arrays, e.g., comprising a large number of antenna elements (AE) to form the multi-band antenna. For example, the antenna device used in a radio cellular network typically includes an antenna array containing 192 AEs (96 dual polarization patches) to synthesize a desired beam pattern.

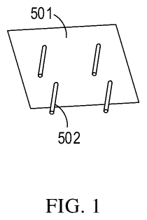

A basic structure of a conventional dual polarization patch antenna used in the base station is shown in FIG. 1. The conventional dual polarization patch antenna comprises a metallized area, i.e., a conductor 501, supported and fed in place by a feeding unit via four feeding conductors 502. The shape of the conductor 501 can in principle be arbitrary. In practice, rectangles, circles, triangles and rings are common shapes. The conductor as shown in FIG. 1 has a substantially rectangular shape.

The two feeding conductors located substantially along a diagonal direction are a pair of feeding conductors. A first pair of feeding conductors 502 are configured to feed a conductor to generate electromagnetic waves of a first polarization direction; the second pair of feeding conductors are for feeding the conductor to generate electromagnetic waves of a second polarization direction. The first polarization direction and the second polarization direction are orthogonal to each other.

A microstrip antenna has a narrow impedance bandwidth in basic form. However, various bandwidth widening techniques have been developed. One such bandwidth broadening technique involves a stack structure which adds a parasitic conductor structure above the radiator over the conductor. A stacked patch arrangement consists of one layer of feeding patch and another layer of parasitic patch, which is one of the popular broadband microstrip antennas. The parasitic patch introduces a second resonance. However, this method increases a size of the radiator and also has limited effect.

In order to increase the bandwidth of the patch radiation element, there is also a method using a resonant tank feed network. In this approach, the feeding of the conductor consists of an open microstrip on a dielectric plate above a ground plane. The microstrip antenna is formed on the separate dielectric plate above the ground plane, and these two structures are electromagnetically coupled through an electrical aperture in the ground plane between them. However, this approach makes the feeding structure and ground structures more complex.

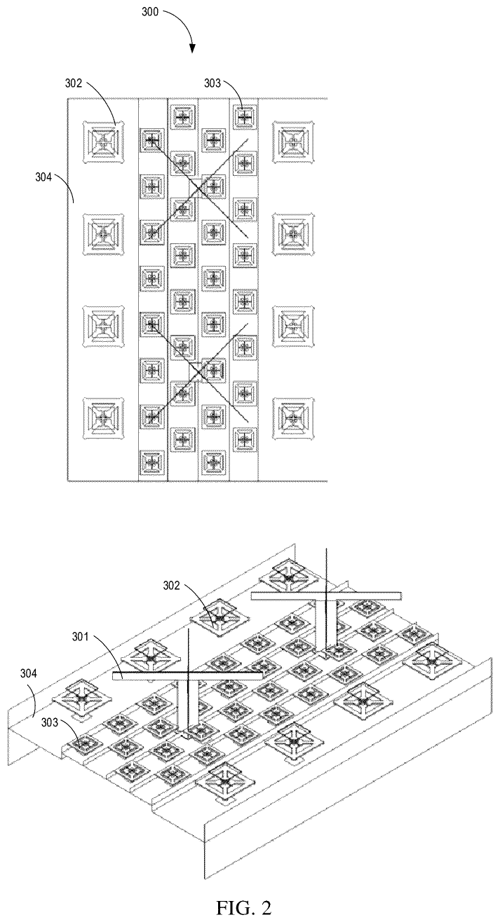

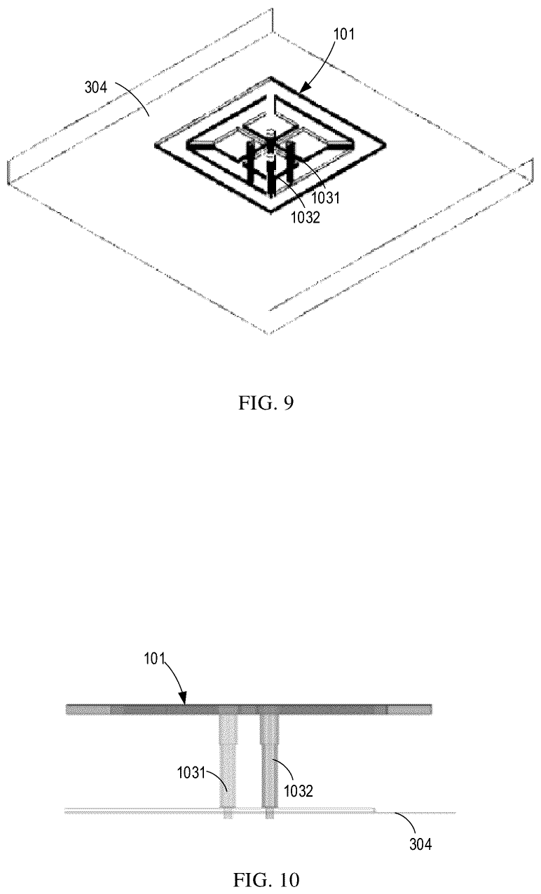

To at least partially address the above and other potential problems, exemplary embodiments of the present disclosure provide the radiator with widened bandwidth and associated antennas which maintain the advantages of patch antennas, including light weight, ease of layout, wide range of applications, compactness, and low cost. Some example embodiments will be described with reference to FIGS. 2 to 16.

FIG. 2 illustrates a top view and a perspective view of a portion of an array antenna 300 used as a multi-band antenna according to an example embodiment of the present disclosure. The multi-band antenna 300 shown in FIG. 2 includes at least three groups of radiators for transmitting and/or receiving electromagnetic waves of different frequency bands, i.e., two low-band radiators 301, eight medium-band radiators 302, and a plurality of high-band radiators 303. In the array arrangement shown in FIG. 2, the radiator is supported on at least one reflector 302. The reflector 302 may be a printed circuit board or a metal sheet located below the radiator to reflect a portion of electromagnetic waves radiated by the plurality of radiators while providing the ground plane layer for the entire radiator.

It is to be understood that references herein to “high-band” and “low-band” are not absolute, but just relative. In other words, both the “high-band” and the “low-band” may belong to any of the high-band frequencies, medium-band frequencies or low-band frequencies known in the art. In other words, with regard to two different frequency bands, whether the two frequency bands belong to a high frequency band, a medium frequency band or a low frequency band known in the art, “high-band” refers to a relatively higher one of the two frequency bands, and “low-band” refers to a relatively lower frequency band.

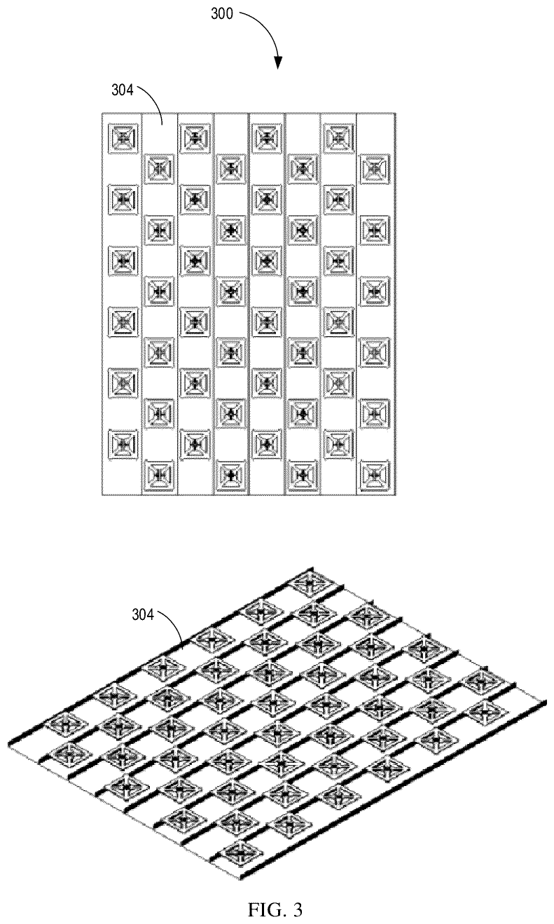

It should also be appreciated that the above-described exemplary embodiments in which the antenna may be the multi-band antenna are for illustration only and are not meant to limit the scope of the present disclosure in any way. In some alternative embodiments, an antenna according to an embodiment of the present invention may also be a large-scale multiple-input multiple-output (MIMO) antenna (as shown in FIG. 3) or the wideband antenna or the like.

In the array arrangement as shown in FIGS. 2 and 3, a radiator 100 according to an exemplary embodiment of the present disclosure may be applied to a medium-high-band radiator to obtain a wider bandwidth. It is to be understood that the antenna arrangements shown in FIGS. 2 and 3 employing radiators according to exemplary embodiments of the present disclosure are for illustrative purposes only and do not imply any limitation on the scope of the present disclosure. The radiator according to exemplary embodiments of the present disclosure may be applied to any suitable multi-band antenna arrangement having one or more mid-high-band radiators and low-band radiators to obtain a widened bandwidth. Hereinafter, the concept of the present disclosure will be discussed in detail by employing an antenna arrangement as shown in FIGS. 2 and 3. Other antenna arrangements with the radiator 100 are similar and will not be described in detail.

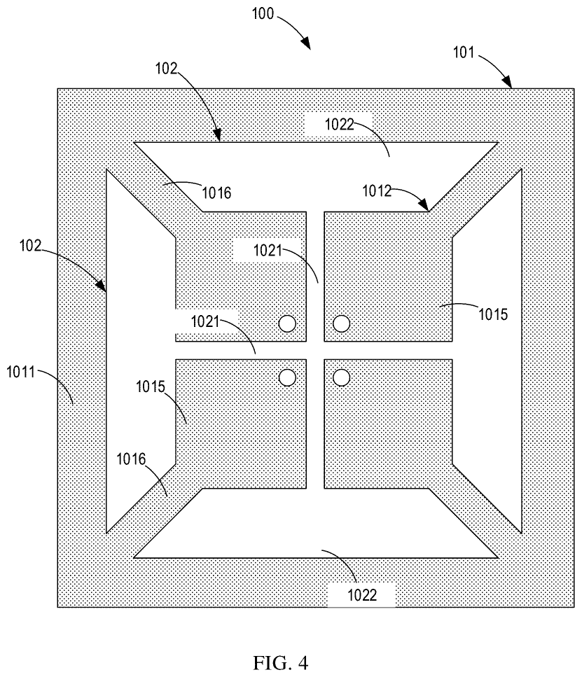

Several example embodiments of the antenna to which the radiator according to example embodiments of the present disclosure may be applied are described above. Several exemplary embodiments of the radiator will be described below in conjunction with FIGS. 4-16.

As shown in FIG. 4, the radiator 100 according to an exemplary embodiment of the present disclosure generally includes a conductor 101. In some example embodiments, the radiator 100 includes, in addition to the conductor 101, the feeding conductor for feeding the conductor 101, as will be described further below. The conductor 101 serves as a radiation portion of the radiator 100 to emit and/or receive the electromagnetic wave. In some example embodiments, the radiator 100 may be the radiator of the patch-structure. The conductor 101 may be made of any suitable electrically conductive material. For example, in some example embodiments, the conductor 101 may be made from a metal sheet, such as a copper sheet, disposed on a printed circuit board used as a substrate. In this manner, the radiator 100 can be manufactured and assembled in a cost-effective manner.

It is to be understood that the exemplary embodiment described above in which the conductor 101 is made from the copper sheet is for illustrative purposes only and is not meant to limit the scope of the present disclosure in any way. The conductor 101 may be fabricated in any suitable manner. For example, in some alternative example embodiments, the conductor 101 may be formed directly from the metal sheet or plate made from a metal such as copper, aluminum, or alloys thereof, without using a printed circuit board as a substrate. Furthermore, in some further alternative example embodiments, the conductor 101 may also be made using any type of metal or conductive material formed on a non-conductive support, such as a plastic support, for example, but not limited to: a molded interconnect device (MID), laser direct structuring (LDS), hot melting a metal plate onto a plastic support, etc.

Further, in some example embodiments, as shown in FIG. 4, the conductor 101 generally has a rectangular shape. It is to be understood that the conductor 101 may also have any suitable shape including, for example, without limitation, rhombus, diamond, circle, oval, rectangle, hexagon, octagon, parallelogram or trapezoid, etc. In addition, the conductor 101 may also have any suitable three-dimensional shape, e.g., frustoconical, cylindrical, semi-cylindrical, etc. Hereinafter, the concepts of the present disclosure will be discussed in detail by explaining a possible shape of the conductor 101 as shown in FIGS. 4-16. Other shapes of the conductor 101 are similar and will not be described in detail.

The radiator 100 also includes a pair of slots 102 formed in the conductor 101. They intersect at a predetermined angle. FIG. 4 shows that the pair of slots 102 are orthogonal to each other in the conductor 101, i.e., intersecting at 90 deg. It is to be understood that the orthogonal intersection of the two slots 102 may also indicate that the angle therebetween may be in the range of 90 deg.±5 deg. due to machining errors and the like. It should also be understood that the two slots 102 may also intersect at any other angle than 90 deg., such as 80 deg. or 75 deg. etc. The concept of the present disclosure will be described by taking orthogonal intersecting slots 102 as an example. Other embodiments where the slots 102 intersect at other suitable angles are similar and will not be described separately hereinafter.

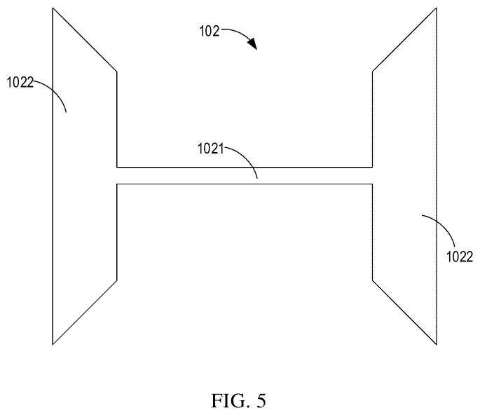

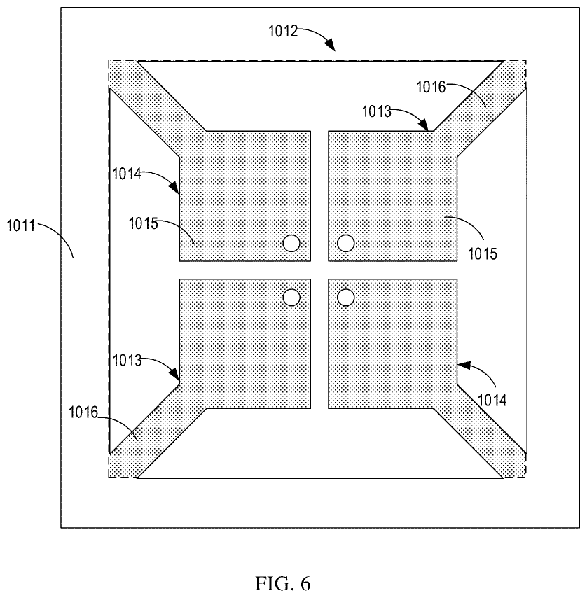

Due to the presence of the slot 102, the slots 102 form a hollow in the conductor 101. The two slots 102 have the same shape and each slot 102 comprises a elongated section 1021 located in the middle and widened sections 1022 located at both ends. The width of the widened section 1022 is wider than the width of the elongated section. That is, the slots 102 are substantially dumbbell shaped, as shown in FIG. 5. Thus, the conductor 101 is divided by the slots 102 into a continuous outer frame portion 1011 and an enclosed portion 1012 surrounded by and connected to the continuous frame portion 1011, as shown in FIGS. 4 and 6.

It is to be understood that the above exemplary embodiment of the two slots 102 having the same shape and size as shown in FIG. 4 is illustrative only and does not imply any limitation on the scope of the present application. In some alternative example embodiments, the two slots 102 may also have different shapes and/or different sizes. The concept of the present application will be discussed by way of example with the exemplary embodiment shown in FIG. 4. The same is true for other cases where the two slots 102 have different shapes and/or different sizes, which will not be described separately in the following.

Although reference is made to dividing the conductor 101 into two parts, i.e., the continuous outer frame portion 1011 and the enclosed portion 1012, this is only for convenience of the following description. It is to be understood that these two parts are integrally formed in the current conductor 101 and realize two modes of operation of the radiator 100 as a whole, as will be discussed further below.

FIGS. 4 and 5 show that the elongated section 1021 has a substantially elongated strip shape. The two slots 102 intersect at a center of the elongated section 1021. As shown in FIG. 5, in some exemplary embodiments, the widened sections 1022 disposed at both ends of the slots 102 each has a trapezoidal shape with a centerline extending generally in the direction of extension of the elongated section 1021. As shown in FIGS. 4 and 5, in some example embodiments, the widened section 1022 has a gradually increasing width in the direction from the center to the end.

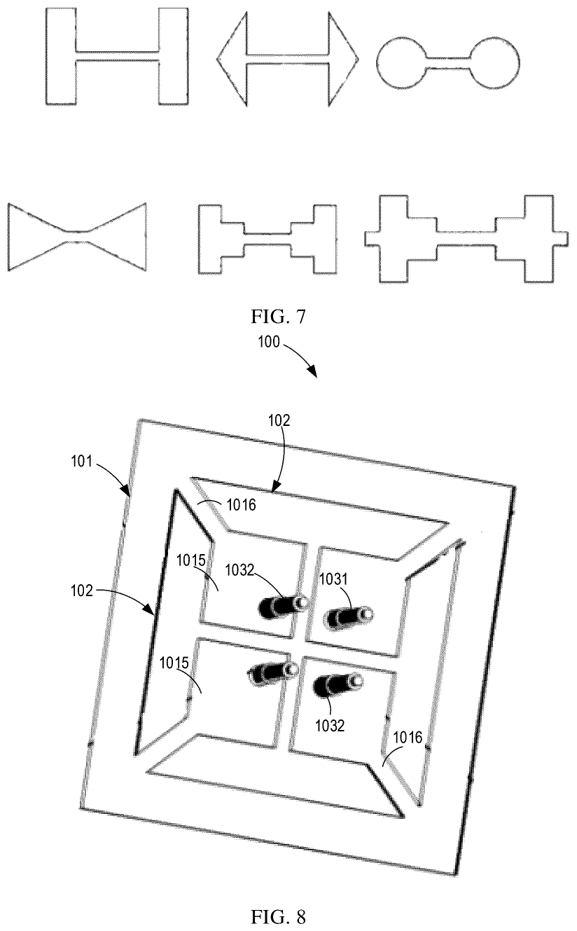

It is to be understood that the above-described embodiments in which the slots 102 have a shape as shown in FIGS. 4 and 5 are for illustrative purposes only and do not imply any limitation on the scope of the present disclosure. Each slot 102 formed in the conductor 101 may also have any other suitable shape. FIG. 7 shows some possible shapes of the slots 102. That is, in some example embodiments, each of the widened sections 1022 may also have a shape including, but not limited to, rectangular, triangular, inverted triangular, circular, or elliptical. In some alternative example embodiments, each of the widened sections 1022 may also have a stepwise increasing width in the direction from the center to the end. It is to be understood that the shape of the slots shown in FIG. 7 is not exhaustive and that any other suitable shape may exist so long as the pair of slots 102 intersecting at a predetermined angle may divide the conductor 101 into the continuous outer frame portion 1011 and the enclosed portion 1012.

It will also be appreciated that the different shapes of the slots 102 will form different shapes of the continuous outer frame portion 1011 and the enclosed portion 1012. The concept of the present disclosure will be discussed by taking the shape of the continuous outer frame portion 1011 and the enclosed portion 1012 shown in FIG. 4 as an example. The continuous outer frame portion 1011 and the enclosed portion 1012 of the other shapes formed by the other shapes of the slots 102 are also similar and will not be described separately in the following.

In some example embodiments, the enclosed portion 1012 includes two pairs of radiation element, i.e., a first pair of radiation elements 1013 and a second pair of radiation elements 1014.

In some example embodiments, the first and second pairs of radiation elements 1013, 1014 may have the same arrangement. Specifically, each of the first and second pairs of radiation elements 1013, 1014 may include a feeding portion 1015 defined by the elongated section 1021 of the slots 102 and a connecting arm 1016 defined by the widened sections 1022. The connecting arm 1016 is arranged to connect the feeding portion 1015 and the continuous outer frame portion 1011, as shown in FIG. 4.

In some example embodiments, the radiator 100 may also include two pairs of feeding conductors 1031, 1032, i.e., four feeding conductors, which are arranged to support the conductor 101, as shown in FIGS. 8-10. The four feeding conductors may include a first pair of feeding conductors 1031 and a second pair of feeding conductors 1032.

The two feeding portions 1015 of the first pair of radiation elements 1013 are coupled to the first feeding unit via the first feeding conductor pair 1031; and the two feeding portions 1015 of the second pair of radiation elements 1014 are coupled to the second feeding unit via the second feeding conductor pair 1032. The first and second feeding units may include first and second feeding ports, respectively, which are disposed in a feed network.

The first feeding unit and the second feeding unit can feed different feeding currents to the radiator 100. In the case where a first feeding current is fed by the first feeding unit, the radiator 100 can operate electromagnetic waves having a first polarization direction. In the case where a second feeding current is fed by the second feeding unit, the radiator 100 can operate electromagnetic waves having a second polarization direction different from the first polarization direction. For example, in some example embodiments, the first polarization direction and the second polarization direction are orthogonal. This arrangement can further widen the bandwidth of an antenna using the radiator 100 according to an exemplary embodiment of the present disclosure.

The first pair of feeding conductors 1031 are coupled to the first feeding port and are configured to feed currents of equal magnitude and opposite phase to the two feeding portions 1015 of the first pair of radiation elements 1013. Similarly, the second pair of feeding conductors 1032 are coupled to the second feeding port for feeding currents of equal magnitude and opposite phase to the two feeding portions 1015 of the second pair of radiation elements 1014.

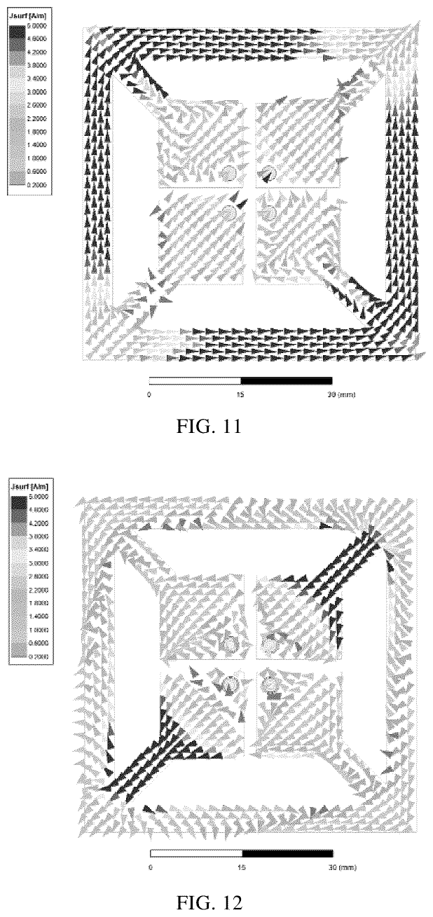

In the following, taking the operating frequency band range of the antenna as 1.7 G-2.4 GHz as an example, how to operate the antenna in two modes is analyzed to achieve the enhancement of bandwidth. The same is true for antennas in other operating bands, which will not be described separately in the following. When the radiator 100 is fed with a current of 1.8 GHz by the first feeding unit, the current distribution on the conductor 101 is shown in FIG. 11. It can be found that the current is concentrated and confined on the continuous outer frame portion 1011, more specifically, on the upper and right edges of the continuous outer frame portion 1011, and the upper and right edges of the continuous outer frame portion 1011 form a half-wavelength slot antenna structure for radiating electromagnetic waves. In this case, the radiator 100 operates in a patch antenna mode.

When the radiator 100 is fed with a current of 2.3 GHz by the first feeding unit, the current distribution on the conductor 101 is shown in FIG. 12. It can be seen that the current is concentrated and confined on the connecting arms 1016 in the lower left and upper right, forming a pair of effective dipole arms for radiation of the electromagnetic waves. In this case, the radiator 100 operates in the dipole antenna mode, and a diagonal length of the conductor 101 corresponds to half a wavelength of a medium corresponding to resonant frequency of the antenna (i.e., 2.3 GHz in this example).

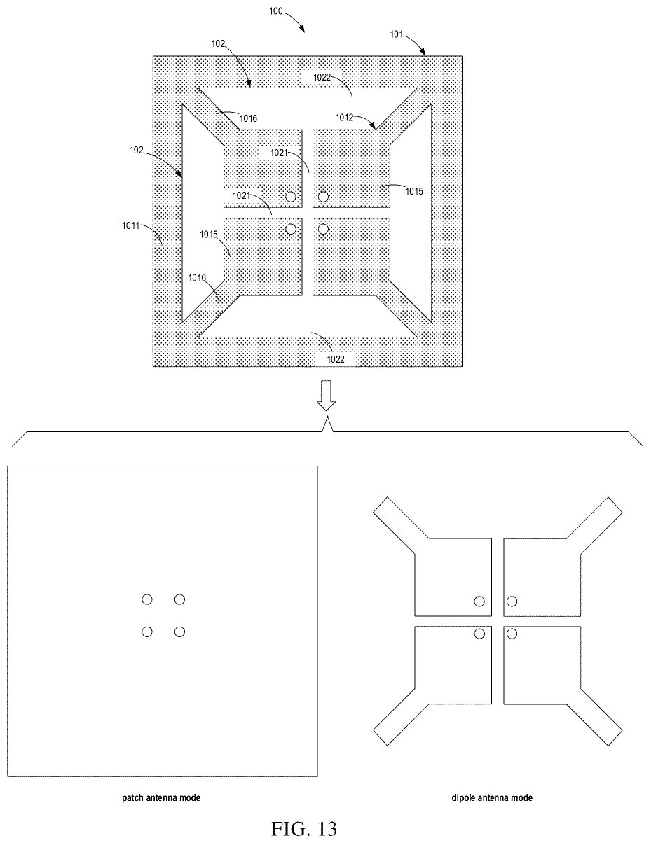

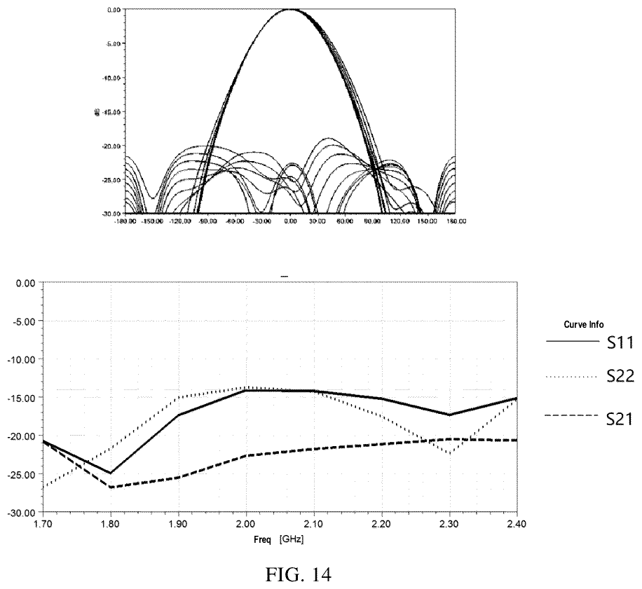

That is, by appropriately sizing the conductor 101 and the slots 102 according to the operating frequency band of the antenna 300, the antenna 300 can effectively operate in two modes, i.e., the patch antenna mode and the dipole antenna mode, as shown in FIG. 13. FIG. 14 illustrates a radiation pattern and S11, S21, and S22 curves of the antenna. It can be seen from FIG. 14 that the bandwidth of the antenna is significantly broadened while maintaining the advantages of the patch antenna of light weight, ease of assembly, compactness, low cost, etc.

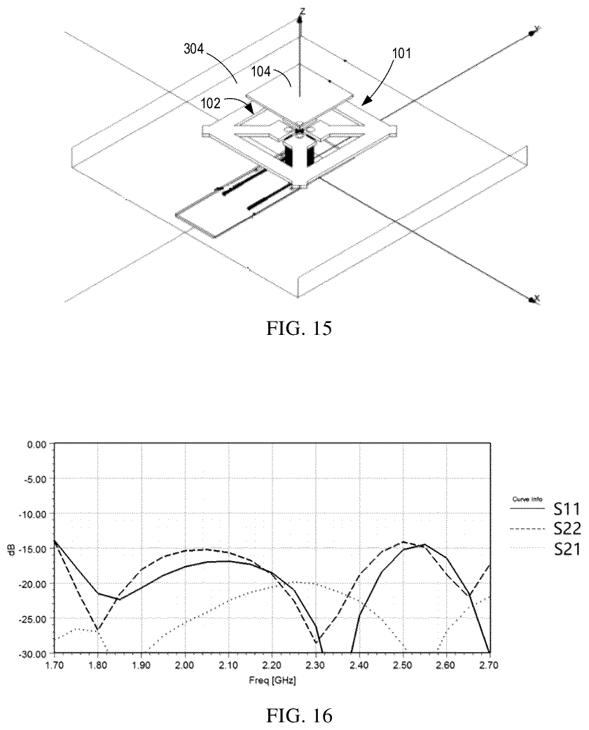

In some example embodiments, to further improve the performance and the bandwidth of the antenna, the radiator 100 may also include at least one parasitic radiation element 104 disposed over the conductor 101, as shown in FIG. 15. The parasitic radiation element is electromagnetically coupled to the conductor 101. From the perspective of launch operation, the parasitic radiation element 104 receives RF electromagnetic energy from the conductor 101 through mutual electromagnetic coupling between the conductor 101 and the conductor 101. The parasitic radiation element 104 is above an electrically isolated area and emits a portion of the received electromagnetic energy in the form of RF-electromagnetic radiation into surrounding space. From the viewpoint of the receiving operation, the parasitic radiation element 104 captures the RF-electromagnetic energy from the RF-electromagnetic radiation falling to the parasitic radiation element 104, and transmits a portion of the captured RF-electromagnetic energy to the conductor 101 through mutual electromagnetic coupling. By means of the parasitic radiation element 104, the performance of the antenna can be further improved, while at the same time the bandwidth of the antenna is further expanded. FIG. 16 shows the S11, S21 and S22 curves of an antenna with the parasitic radiation element 104. It can be seen from FIG. 16 that the bandwidth and the performance of the antenna with the parasitic radiation element 104 is further improved compared to the embodiment of the radiator 100 without the parasitic radiation element 104.

According to another aspect of the present disclosure, there is provided a base station. The base station comprises the at least one antenna as described above. The antenna can improve the performance of the characteristics of the base station, such as gain and radiation pattern.

It is to be understood that the above detailed embodiments of the disclosure are merely illustrative or explanatory of the principles of the disclosure and are not restrictive of the disclosure. Thus, it is intended that the present disclosure cover the modifications, equivalents, and alternatives falling within the spirit and scope of the present disclosure. Meanwhile, the claims attached to the present disclosure are intended to cover all variations and modifications to the equivalent replacement scope and boundaries falling into the scope and boundaries of the claims.

1. A radiator, comprising:
a conductor adapted to be arranged in an antenna for transmitting and/or receiving electromagnetic waves; and
a pair of slots formed in the conductor and intersecting at a predetermined angle, each of the pair of slots comprising an elongated section at the middle thereof and widened sections at both ends thereof such that the conductor is divided by the pair of slots into:
a continuous outer frame portion; and
an enclosed portion surrounded by and connected to the continuous outer frame portion.

2. The radiator according to claim 1, further comprising:
two pairs of feeding conductors for feeding the conductor.

3. The radiator according to claim 2, wherein the two pairs of feeding conductors are arranged to support the conductor and comprise a first pair of feeding conductors and a second pair of feeding conductors.

4. The radiator according to claim 3, wherein the enclosed portion comprises:
a first pair of radiation elements coupled to a first feeding unit through the first pair of feeding conductors; and
a second pair of radiation elements coupled to a second feeding unit through the second pair of feeding conductors.

5. The radiator according to claim 4, wherein the radiator is configured to operate electromagnetic waves having different polarization directions by feeding different feeding currents through the first feeding unit and the second feeding unit.

6. The radiator according to claim 4, wherein each of the first pair of radiation elements and the second pair of radiation elements comprises:
a pair of radiation conductors symmetrical with respect to an intersection center of a diagonal of the conductor, each radiation conductor comprising:
a feeding portion defined by the elongated sections of the pair of slots and connected to a corresponding one of the first and second feeding units; and
a connecting arm defined by the widened sections of the pair of slots for connecting the feeding portion and the continuous outer frame portion.

7. The radiator according to claim 6, wherein the connecting arm extends diagonally.

8. The radiator according to claim 1, wherein each of the widened sections has a gradually increasing or stepwise increasing width in a direction from a center to an end.

9. The radiator according to claim 1, wherein the pair of slots are orthogonal to each other.

10. The radiator according to claim 1, wherein the conductor has one or more of the following shapes: rhombus, diamond, circle, oval, rectangle, hexagon, octagon, parallelogram and trapezoid.

11. The radiator according to claim 1, wherein the continuous outer frame portion and the enclosed portion are arranged in the same plane.

12. The radiator according to claim 1, wherein the radiator is a patch-structure radiator.

13. The radiator according to claim 1, further comprising:
at least one parasitic radiation element arranged above the conductor.

14. An antenna, comprising:
a plurality of the radiators according to claim 1;
at least one reflector on which the plurality of the radiators are supported, the at least one reflector being configured to reflect a portion of the electromagnetic waves radiated by the plurality of the radiators; and
the first feeding unit and the second feeding unit, both of which are configured to feed the plurality of the radiators.

15. The antenna of claim 14, wherein the antenna comprises a large-scale MIMO antenna, a wideband antenna, or a multi-band antenna.

16. A base station comprising the at least one antenna according to claim 14.
